(19) United States
(12) Patent Application Publication
(10) Pub. No.: US 2007/0036378 A1
(43) Pub. Date: Feb. 15, 2007

(54) Shock resistant and vibration isolated electroacoustical transducer assembly

(75) Inventors: Oleg Saltykov, Fairlawn, NJ (US); Xinche Yan, Glendale Heights, IL (US); Henry G. Nepomuceno, Glendale Heights, IL (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: KNOWLES ELECTRONICS, LLC, Itasca, IL (US)

(21) Appl. No.: 11/182,151

(22) Filed: Jul. 15, 2005

(51) Int. Cl. H04R 25/00

(52) U.S. Cl. 381/324

(57) ABSTRACT

A shock resisting vibration damping mounting for an acoustic transducer includes a compliant first portion or boot coupled to a compliant second portion or tube. The first portion has an exterior surface and an interior surface with the interior surface defining a chamber for receiving the acoustic transducer. The second portion has an elongate portion having a first end and a second end and a passage extending within the elongate portion from the first end to the second end. The passage couples to the chamber such that with an acoustic transducer disposed within the chamber a port of the acoustic transducer is acoustically coupled to the passage.

### TECHNICAL FIELD

This patent generally relates to transducers, and more particularly, to a receiver assembly with a suspension apparatus capable of dampening the vibrations caused by the receiver assembly and/or other components within listening devices and to further provide protection from shock loadings.

### BACKGROUND

Hearing aid technology has progressed rapidly in recent years. Technology advancements in this field continue to improve the reception, wearing-comfort, life-span, and power efficiency of hearing aids. With these continual advances in performance of ear-worn acoustic devices, ever-increasing demands are placed upon improving the inherent performance of the miniature acoustic transducers that are utilized. There are several different hearing aid styles known in hearing aid industry: Behind-The-Ear (BTE), In-The-Ear or All-In-The-Ear (ITE), In-The-Canal (ITC), and Completely-In-The-Canal (CIC).

Generally, a listening device, such as a hearing aid, includes a microphone portion, an amplification portion, and a receiver portion. The microphone portion receives sound waves in audible frequencies and generates an electronic signal representative of these sound waves. The amplification portion accepts the electronic signal, increases the electronic signal magnitude, and communicates the increased electronic signal (e.g. the processed signal) to the receiver portion. The receiver portion, in turn, converts the increased electronic signal into sound waves for transmission to a user.

Typically, the sound waves produced by the receiver give rise to reaction forces which cause the receiver to vibrate. Such vibrations in the receiver may be detected by the microphone within the hearing aid, causing unwanted feedback and distortion which adversely affects the sound quality experienced by the hearing aid user. Also, shock loading, e.g. from the hearing aid being dropped, may easily damage the transducers within the hearing aid thereby reducing the performance of the hearing aid. Further, the receiver typically includes a spout adjacent to the sound outlet port to conduct the sound waves from the receiver to the user. The large dimension of the spout can be a problem because there is only very limited space within the hearing aid shell. In addition, mounting a spout to the receiver can be problematic in some types of hearing aids, such as CIC hearing aids because the spout must be aligned with and couple an output of the received to an output of the hearing aid to the environment. However, the position of the receiver in the hearing aid is often constrained.

### BRIEF DESCRIPTION OF THE DRAWINGS

For a more complete understanding of the disclosure, reference should be made to the following detailed description and accompanying drawings wherein:

FIG. 1 is a cross-sectional view of a portion of a described embodiment of a receiver assembly;

FIG. 2 is a perspective view of the receiver assembly of FIG. 1;

FIG. 3 is a perspective view of another described embodiment of a receiver assembly having two acoustic apertures;

FIG. 4 is a perspective view of an embodiment of a conjoined microphone and receiver assembly;

FIG. 5 is a cross-sectional view of a portion of an embodiment of a receiver assembly incorporating a shock resistant and vibration absorber system;

FIG. 6 is a perspective view of the receiver assembly of FIG. 5;

FIG. 7 is a perspective view of an embodiment of a shock resisting and vibration absorbing system;

FIG. 8 is a perspective view of another embodiment of a shock resisting and vibration absorbing system;

FIG. 9 is a cross-sectional view of an embodiment of a receiver assembly incorporating a shock resisting and vibration absorbing system; and

FIG. 10 is a perspective view of the shock resisting and vibration absorbing system of FIG. 9.

### DETAILED DESCRIPTION

While the present apparatus, devices, systems and methods described in this disclosure are susceptible to various modifications and alternative forms, certain embodiments are shown by way of example in the drawings and these embodiments will be described in detail herein. It will be understood, however, that this disclosure is not intended to limit the invention to the particular embodiments or forms described, but to the contrary, the invention is intended to cover all modifications, alternatives, and equivalents falling within the spirit and scope of the invention defined by the appended claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Unless a claim element is defined by reciting the word “means” and a function without the recital of any structure, it is not intended that the scope of any claim element be interpreted based on the application of 35 U.S.C. §112, sixth paragraph.

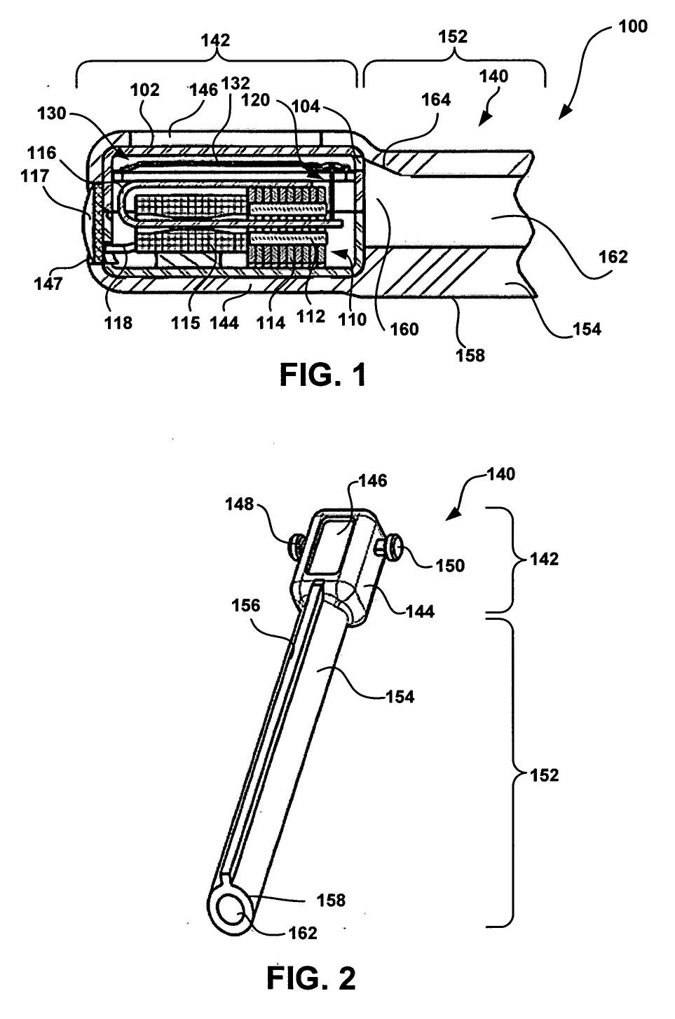

FIGS. 1-2 illustrate a transducer 100 that can be used in virtually any type of hearing aid, such as BTE, ITE, ITC, CIC, or the like type hearing aids. The transducer 100 may be adapted as either a microphone, a receiver or other such device, and may be useful in such devices as listening devices, hearing aids, headphones, and hearing protection devices. In the embodiment shown, the transducer 100 is a receiver assembly. The receiver assembly 100 includes a motor assembly 110, a coupling assembly 120, and an acoustic assembly 130 disposed within a housing 102. The housing 102 may be rectangular and consist of at least one sound aperture 104 positioned adjacent to one corner of the housing 102 for broadcasting acoustic signals to the user. In alternate embodiments, the housing 100 can be manufactured in a variety of configurations, such as a cylindrical shape, a D-shape, a trapezoid shape, a roughly square shape, a tubular shape, or any other desired geometry. In addition, the scale and size of the housing may vary based on the intended application, operating conditions, required components, etc. Moreover, the housing 102 can be manufactured from a variety of materials, such as, for example stainless steel, nickel-iron alloy, alternating layers of conductive materials, or alternating layers of non-conductive layers (e.g. metal particle-coated plastics). The motor assembly 110 includes a drive magnet 112, a magnetic yoke 114, a coil 115, an armature 116, an electrical terminal 117, and a lead 118 that couples the electrical terminal 117 and the coil 115. The electrical terminal 118 may be affixed to the side wall of the housing 102 by bonding or any other suitable method of attachment. The acoustic assembly 130 includes at least one diaphragm 132 having a first layer, a second layer, and a flexible layer. One of ordinary skill in the art will appreciate that the diaphragm 132 may be of a different configuration such as disclosed in U.S. patent application Ser. No. 10/719,809 and 60/665,700, the disclosures of which are incorporated herein by reference. The coupling assembly 120 may be a drive rod, a linkage assembly, a plurality of linkage assemblies, or the like.

The motor assembly 110 is connected to the acoustic assembly 130 via the coupling assembly 120 to drive the acoustic assembly 130. The arrangement of the acoustic assembly 130 permits the transfer of electrical signal energy to acoustic sound wave energy, i.e. vibrational energy in the acoustic assembly 130 or to transfer vibrational energy in the acoustic assembly 130 into electrical signal energy. The transmission of the vibrational energy through the sound aperture 104 causes the entire receiver assembly 100 to vibrate. The vibration of the receiver assembly 100 is then picked up by the microphone (not shown), amplified, and provided to the input of the receiver assembly 100, thus resulting in unwanted feedback and distortion. Furthermore, if the receiver assembly 100 comes into physical contact with the inner surface of the hearing aid (not shown) or other components within the hearing aid, such vibration may be transferred to the hearing aid. If the hearing aid is dropped and there is shock loading on the receiver assembly 100, the motor assembly 110, the coupling assembly 120, and the acoustic assembly 130 within the housing 102. These components may be deflected beyond their elastic limits as result of the shock loading causing plastic deformation of these components adversely affecting the performance of the hearing aid.

The receiver assembly 100 incorporates a shock resisting and vibration isolating structure 140 that has substantial damping and compliance properties. The shock resisting and vibration isolating structure 140 includes a boot portion 142 and a tube portion 152 extending from the boot 142. The boot portion 142 may be made of a an elastomer or synthetic elastomer such as a fluoroelastomer, commonly available under the trade name VITON and under other trade names, natural rubber, or similar materials capable of providing shock absorbing and vibration dampening. The boot portion 142 is designed to be tight fitted around the receiver assembly 100. The boot portion 142 includes a sleeve 144 and at least one opening 146 formed in the sleeve 144. The sleeve 144 will typically be shaped to correspond to the external configuration of the receiver housing 102, but may be shaped in various ways and adapted to compliment the external configuration of the receiver housing. The boot portion 142 is fitted around the receiver assembly 100 to minimize mechanical vibration feedback. The opening 146 formed on the top wall of the sleeve 144 receives the receiver assembly 100. In alternate embodiment, the opening 146 or a second opening (not shown) may be formed on the bottom wall of the boot portion 142 that serves the same purpose. For certain applications, an optional opening 147 may be formed on the rear wall of the sleeve 144 through which the electrical terminal 117 extends to receive electrical connection from the components within the hearing aid (not shown).

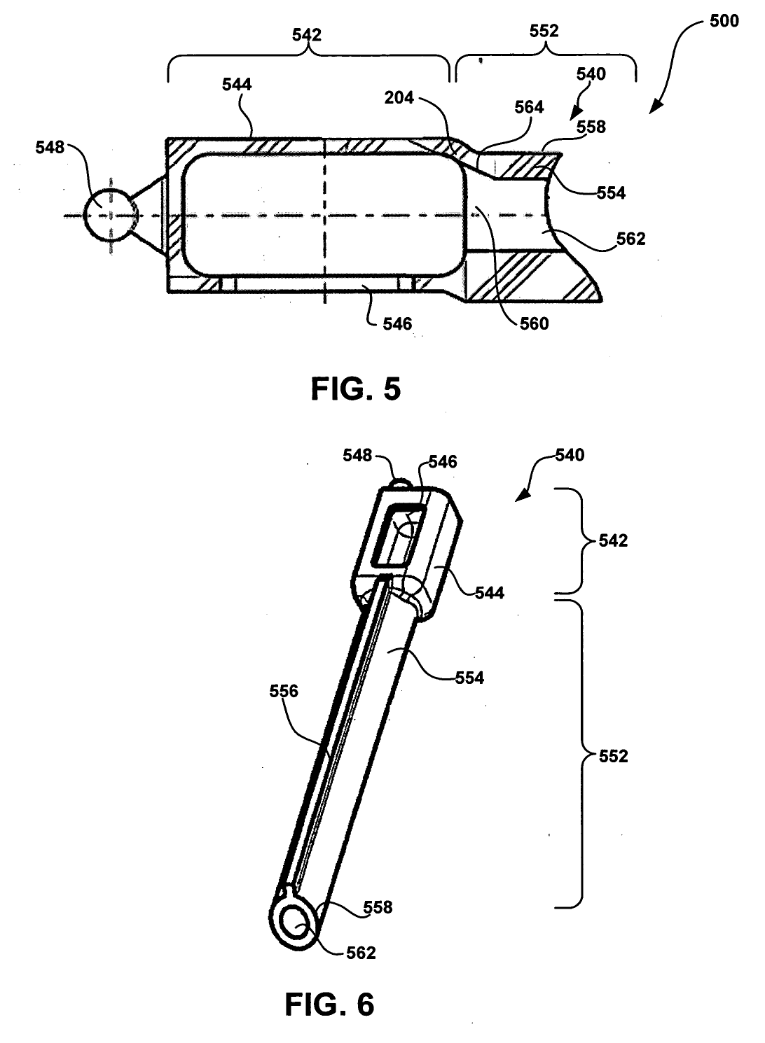

FIG. 2 illustrates for the shock resisting and vibration isolating structure 140 optional protrusions 148, 150 formed on the side, walls of the sleeve 144 adjacent to the rear side of the receiver assembly 100. While two protrusions 148 and 150 are depicted, fewer or more may be included. The protrusions 148 and 150 provide shock resistance and vibration isolation for the receiver assembly 100 to reduce vibration that is transmitted from the receiver to the hearing aid and the components within the hearing aid. The protrusions 148, 150 of the sleeve 144 further help to suspend the receiver assembly 100 within the hearing aid at a distance separated from the hearing aid shell to further reduce vibration transmission. In an alternate embodiment, the protrusion may be formed on the rear wall of the sleeve (see, e.g., FIGS. 5-6). The protrusions 148, 150 may be fabricated from the same material as the boot portion 142, for example a fluoroelastomer. The protrusions may further be formed in a variety of shapes to accommodate different supporting members (not shown) within the hearing aid.

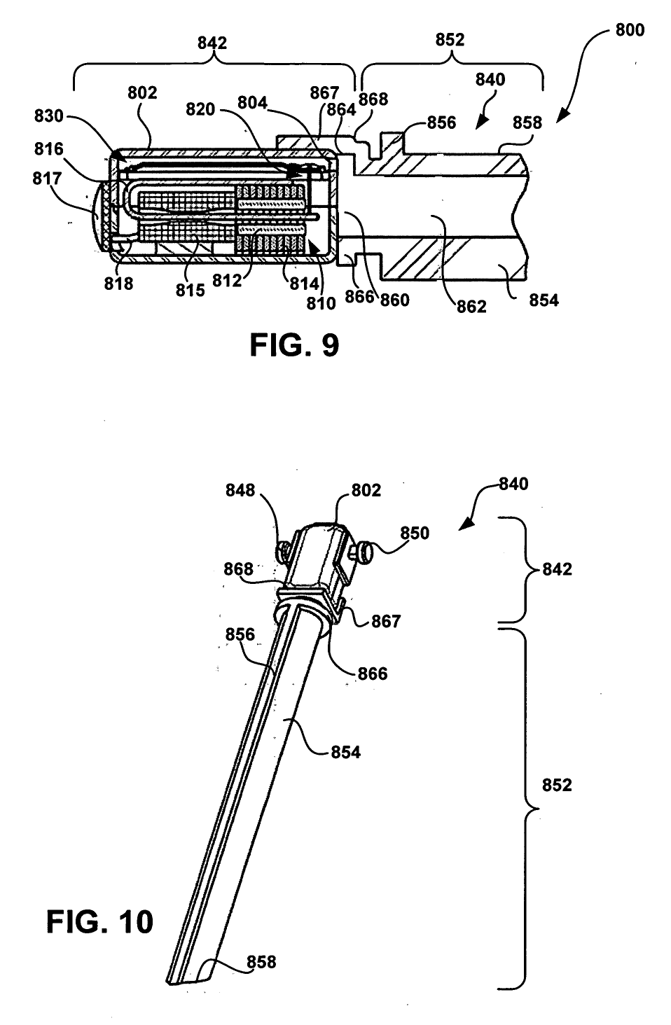

The tube portion 152 can be formed integral with the boot portion 142 or separately and adhered to the boot portion 142. The tube portion 152 includes a tubular segment 154 and at least one spline 156. The tubular segment 154 includes an outer wall 158 and an interior recess 160 (see FIG. 1). A passageway 162 extends within the outer wall and coupled to the interior recess 160. The interior recess 160 is configured to be large enough to overlap with the sound aperture 104 of the receiver assembly 100. As illustrated in FIG. 1, the recess 160 is wider than the passageway 162 having a surface 164 formed at a predetermined angle adjacent to the sound aperture 104 of the receiver assembly 100. In operation, the surface 164 serves to direct the acoustic sound waves emitted from the sound aperture 104 of the receiver assembly 100 into the passageway 162 of the tubular segment 154 so that the sound waves are transmitted from the receiver 100 along the passage 162 and out of the hearing aid. An annular flange (see FIGS. 9-10) may be formed on the outer wall 158 of the tubular segment 154 to suspend the receiver assembly 100 within the hearing aid. The spline 156 is formed on the outer wall of the tubular segment 154 for anchoring the receiver assembly 100 in a predetermined position within the hearing aid. The spline 156 may further provide shock resistance and vibration isolation for the receiver assembly 100 and reduce vibration that is transmitted to the hearing aid and the components within the heading aid. The annular flange and the spline 156 may further restrict the motion of the receiver assembly 100 within the hearing aid when the hearing aid is subjected to shock loading.

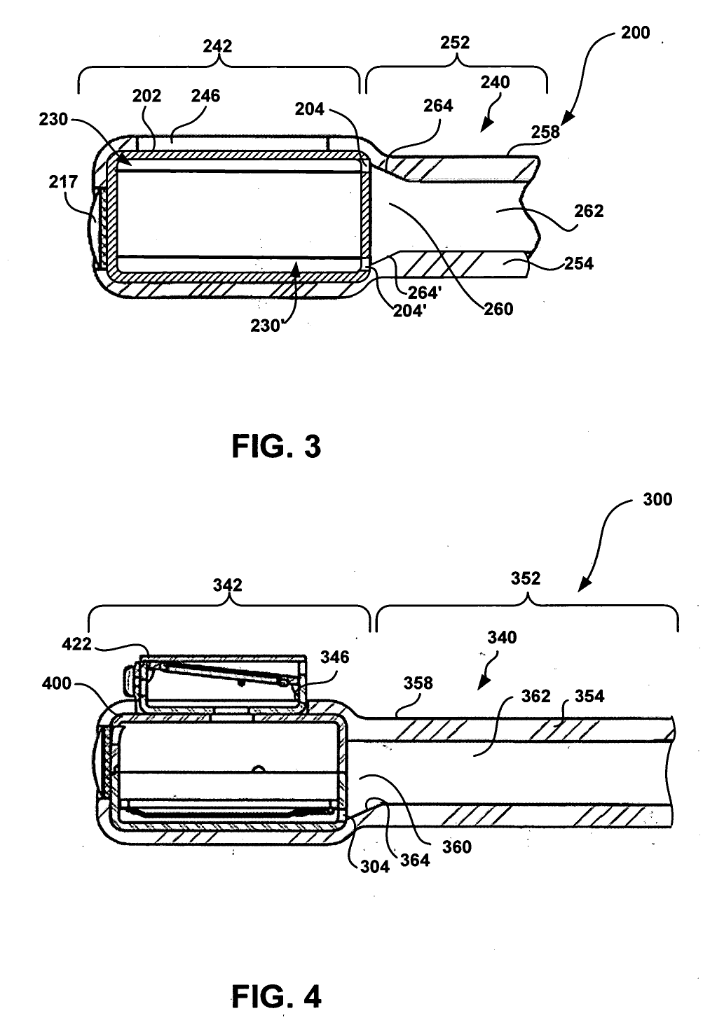

FIG. 3 illustrates a receiver assembly 200 incorporating a shock resisting and vibration isolating system 240. The embodiment 200 is similar to the embodiment illustrated in FIGS. 1-2. The receiver assembly 200 comprises two acoustic assemblies 230, 230′ and two sound apertures 204, 204′ formed on the housing 202 adjacent to the acoustic assemblies 230, 230′. Two in-phase acoustic assemblies 230, 230′ are coupled to the motor assembly (not shown) via the coupling assembly (not shown) to produce a greater acoustic sound wave that corresponds to an audio signal received at the electrical terminal 217 positioned on the external surface of the housing 202.

The shock resisting and vibration isolating system 240 has substantial resilience and compliance and includes a boot portion 242 and a tube portion 252 attached to the boot 242. The tube portion 252 may be formed integral with the boot portion 242 and includes a tubular segment 254, at least one spline (not shown), and an annular flange (not shown). The tubular segment 254 includes an outer wall 258 and an interior recess 260. A passageway 262 extends within the outer wall 258 and couples to the interior recess 260. The interior recess 260 is configured to be large enough to overlap with the sound apertures 204, 204′ of the receiver assembly 200. As shown, the recess 260 is wider than the passageway 262 and has a first surface 264 arranged at a first predetermined angle and a second surface 264′ arranged at a second predetermined angle adjacent to the sound apertures 204, 204′, respectively, of the receiver assembly 200. In operation, the first and second surfaces 264, 264′ serve to direct the acoustic sound waves emitted from the sound apertures 204, 204′ of the receiver assembly 200 into the passageway 262 of the tubular segment 254 so that the sound waves are transmitted out of the hearing aid.

FIG. 4 illustrates a conjoined assembly 300 partially encapsulated in a shock resisting and vibration isolating system 340. The conjoined assembly 300 includes a receiver assembly 400 and a microphone assembly 422 mounted in back-to-back abutting relation. The back-to-back abutting arrangement allows the back value 410 of the receiver to be joined with a volume 412 of the microphone assembly 422 to increase the effective volume of the receiver assembly increasing its efficiency particularly at low frequencies. In alternate embodiments, the microphone assembly 422 and the receiver assembly 400 can be mounted in front-to-front alignment. A portion of the conjoined assembly 300 is partially encapsulated in the system 340 such that the receiver assembly 400 is substantially tightly fitted within the boot portion 342 of the system 340 and a portion of the microphone assembly 422 extends through the opening 346 of the boot 342. A surface 364 is formed in the recess 360 at a predetermined angle 364 and is disposed adjacent to the sound aperture 304 for directing the acoustic sound waves emitted from the sound aperture 304 of the conjoined assembly 300 into the passageway 362 of the tubular segment 354 and from the hearing aid.

FIGS. 5-6 illustrate a receiver assembly 500 encased in a shock resisting and vibration isolating system 540. A protrusion 548 is formed on the rear wall of the boot portion 542 to provide shock resistance and vibration isolation for the receiver assembly 500 to reduce vibration transmitted to the hearing aid and the components within the heading aid. The protrusion 548 further helps to suspend the receiver assembly 500 within the hearing aid at a distance separated from the hearing aid shell to reduce vibration transmission. A tube portion 552 may be formed integral with the boot portion 542 and includes a tubular segment 554, at least one spline 556, and an annular flange (not shown). A surface 564 is formed at a predetermined angle within the recess 560 adjacent to the sound apertures (not shown) of the receiver assembly 500. The surface 564 directs acoustic sound waves emitted from the sound aperture of the receiver assembly 500 into the passageway 562 of the tubular segment 554 so that the sound waves are transmitted out of the hearing aid. The interior recess 560 is configured to be large enough to overlap with the sound aperture of the receiver assembly 500 and the recess 560 is wider than the passageway 562.

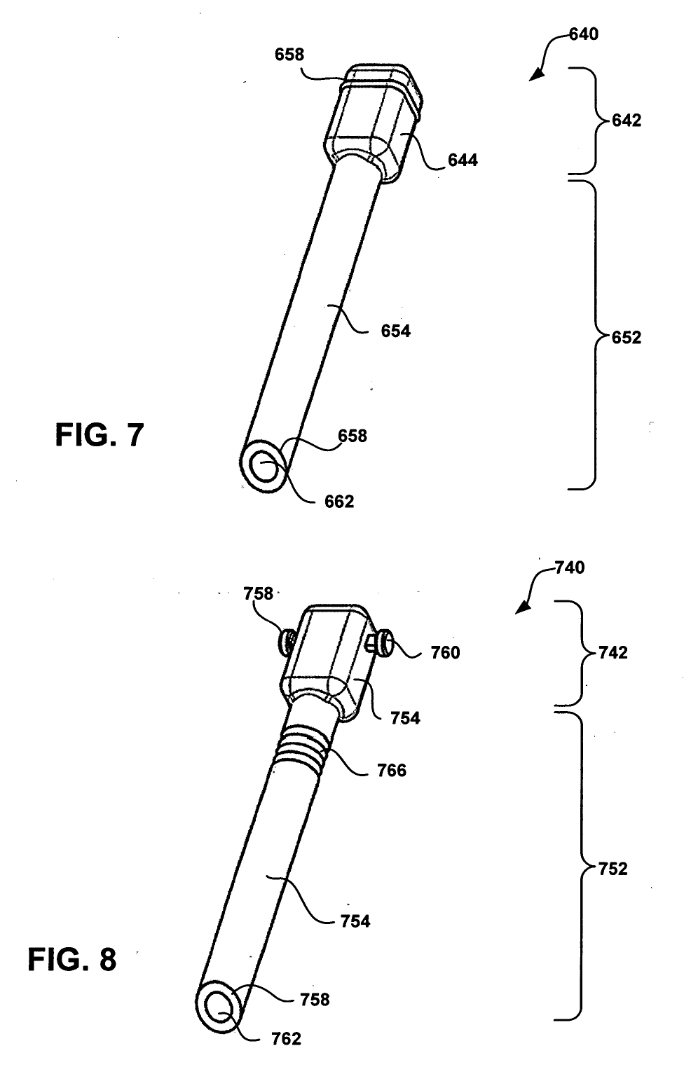

FIG. 7 illustrates a shock resisting and vibration isolating system 640 that is similar to the embodiments illustrated in FIGS. 1-6. An annular protrusion 658 is formed on the sleeve 644 to provide shock resistance and vibration isolation for a receiver assembly (not shown) disposed within the boot portion 642. The protrusion 658 further help to suspend the receiver assembly within the hearing aid at a distance separated from the hearing aid shell to reduce vibration transmission from the receiver to the hearing aid and its components. The tube portion 652 of the system 640 includes a tubular segment 654 and a spline (not shown). The tube portion 652 may be similar in construction to the tub portion 152 illustrated in FIGS. 1-2.

FIG. 8 illustrates a shock resisting and vibration isolating system 740 that is similar in construction to the embodiments illustrated in FIGS. 1-7. A plurality of annular flanges 766 is formed on the outer wall 758 of the tubular segment 754 to suspend the receiver assembly within the hearing aid. In an alternate embodiment, the flange 766 may be formed adjacent to the front side of the receiver assembly (see FIG. 10) and communicates with the sound aperture of the receiver assembly. The annular flange 766 may further restrict the motion of the receiver assembly within the hearing aid when the hearing aid is subjected to shock loading. A spline (not shown) is formed on the outer wall of the tubular segment 754 for anchoring the receiver assembly in a predetermined position within the hearing aid.

FIGS. 9-10 illustrates a receiver assembly 800 encased in a shock resisting and vibration isolating system 840. The receiver assembly 800 is similar in construction to the assembly 100 illustrated in FIG. 1. The system 840 includes at least two protrusions, 848, 850 and a tube portion 852. The tube portion 852 includes an L-shaped side wall 867 and an outer wall 868 connecting to the side wall 867. The side wall 867 is coupled to the receiver housing 802 by any suitable method of attachment, such as adhesive or glue. The tube portion 852 may further include a tubular segment 854 and the outer wall 868 may be integrally formed with the tubular segment 854.

The tubular segment 854 includes an outer wall 858 and an interior recess 860 (see FIG. 9). A passageway 862 extends within the outer wall 858 and couples to the interior recess 860. The interior recess 860 is configured to be large enough to overlap with the receiver sound aperture 804. As illustrated in FIG. 9, the recess 860 is wider than the passageway 862 and has a surface 864 formed on the upper surface of the recess 860 adjacent to the receiver sound aperture 804 and at a predetermined angle thereto. In operation, the surface 864 serves to direct the acoustic sound waves emitted from the receiver sound aperture 804 into the passageway 862 of the tubular segment 854 so that the sound waves are transmitted out of the hearing aid. An annular flange 866 may be formed on the outer wall 858 of the tubular segment 854 adjacent to the outer wall 868 and the receiver sound aperture 804 to suspend the receiver assembly 800 within the hearing aid. The annular flange 866 may further restrict the motion of the receiver assembly 800 within the hearing aid when the hearing aid is subjected to shock loading. A spline 856 is formed on the outer wall of the tubular segment 854 adjacent to the flange 866 for anchoring the receiver assembly 800 in a predetermined position within the hearing aid.

In the embodiments described above, a system having substantial damping and compliance include a tube portion is used. Thus, the system compliance together the receiver mass formed a second-order mechanical filter to provide a highly compliant suspension means for maximum vibration isolation. A recess of the tube portion having a predetermined angle adjacent to the sound aperture of a spoutless receiver assembly serves to direct the acoustic sound waves broadcasted from the sound aperture so that the sound waves are transmitted out of the hearing aid for preventing any acoustic leakage.

All references, including publications, patent applications, and patents, cited herein are hereby incorporated by reference to the same extend as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. An acoustic transducer comprising:
a transducer housing defining a volume and an exterior surface, an electric terminal formed on the exterior surface and a port coupling the volume to the environment;
an compliant member having a first portion and a second portion, the first portion defining a chamber for receiving the transducer housing, the chamber being sized to elastically engage the exterior surface; the second portion defining a passage, the passage being adjacent to the port when the transducer housing is disposed within the chamber.

2. The acoustic transducer of claim 1, wherein the passage comprises a recess, the recess being adjacent to the port, the recess acoustically coupling the port to the passage.

3. The acoustic transducer of claim 2, the recess being larger in size than the port.

4. The acoustic transducer of claim 2, the recess including a surface, the surface being disposed at an angle to the port, the angle being selected to facilitate communication of sound waves between the port and the passage.

5. The acoustic transducer of claim 1, the first portion comprising a member projecting outwardly from an exterior surface of the first portion, the member being compliant and the member sized to engage an interior surface of a device housing within which the acoustic transducer is disposed for positioning the acoustic transducer within the device housing.

6. The acoustic transducer of claim 1, the second portion comprising a member projecting outwardly from an exterior surface of the second portion, the member being compliant.

7. The acoustic transducer of claim 6, wherein the member comprises a ring extending around an exterior circumference of the second member.

8. The acoustic transducer of claim 6, wherein the member comprises a spline extending axially along an exterior surface of the second member.

9. The acoustic transducer of claim 8, wherein the spline engages a device housing for positioning the acoustic transducer within the device housing.

10. The acoustic transducer of claim 1 the compliant member being formed of an elastomer material, a fluoroelastomer material or rubber.

11. The acoustic transducer of claim 1, the first portion comprising an opening exposing the electric terminal.

12. The acoustic transducer of claim 1, wherein the first portion and the second portion comprise a single member.

13. The acoustic transducer of claim 1, wherein the receiver comprises a second port in communication with the passage.

14. The acoustic transducer of claim 13, wherein the passage comprises a recess, the recess being adjacent to each of the port and the second port, the recess acoustically coupling the port and the second port to the passage.

15. The acoustic transducer of claim 14, the recess including a first surface and a second surface, the first surface and the second surface being disposed at an angle to the port and the second port, respectively, the respective angle of the first surface and the second surface being selected to facilitate communication of sound waves between the port and the second port and the passage.

16. A shock resisting vibration damping mounting for an acoustic transducer comprising:
a compliant first portion coupled to a compliant second portion, the first portion having an exterior surface and an interior surface, the interior surface defining a chamber for receiving the acoustic transducer;
the second portion having an elongate portion having a first end and a second end and a passage extending within the elongate portion from the first end to the second end, the passage being coupled to the chamber such that with an acoustic transducer disposed within the chamber a port of the acoustic transducer is acoustically coupled to the passage.

17. The shock resisting vibration damping mounting of claim 16, wherein the second portion comprises a recess coupled to the passage, the recess being disposed adjacent the chamber.

18. The shock resisting vibration damping mounting: of claim 17, the recess comprising a surface, the surface disposed at an angle with respect to the chamber, the surface being operable to direct sound waves from an acoustic transducer disposed within the chamber into the passage.

19. The shock resisting vibration damping mounting of claim 16, the first portion and the second portion being integrally formed.

20. The shock resisting vibration damping mounting of claim 16, the first portion comprising a member projecting outwardly from an exterior surface of the first portion, the member being compliant and the member sized to compliantly engage an interior surface of a device housing.

21. The shock resisting vibration damping mounting of claim 16, the second portion comprising a member projecting outwardly from an exterior surface of the second portion, the member being compliant.

22. The shock resisting vibration damping mounting of claim 21, wherein the member comprises a ring extending around an exterior circumference of the second member.

23. The shock resisting vibration damping mounting of claim 21, wherein the member comprises a spline extending axially along an exterior surface of the second member.

24. The shock resisting vibration damping mounting of claim 16, the shock resisting vibration damping mounting being formed of an elastomer material, a fluoroelastomer material or rubber.
